(19) United States
(12) Patent Application Publication
(10) Pub. No.: US 2025/0088051 A1
(43) Pub. Date: Mar. 13, 2025

(54) Rotor for an Axial Flux Machine Having Axial Binding Arrangement

(71) Applicant: Bayerische Motoren Werke Aktiengesellschaft, Muenchen (DE)

(72) Inventors: Alena BABL, Holzkirchen (DE); Matthias Dorfner, Muenchen (DE); Zakaria El Khawly, Muenchen (DE); Jerome Ragot, Muenchen (DE)

(21) Appl. No.: 18/826,340

(22) Filed: Sep. 6, 2024

(30) Foreign Application Priority Data
Sep. 7, 2023 (DE) 10 2023 124 049.8

(51) Int. Cl. H02K 1/2793; H02K 1/24; H02K 15/03

(52) U.S. Cl. CPC H02K 1/2793; H02K 1/24; H02K 15/03

(57) ABSTRACT

An electric axial flux machine includes a permanent magnet arrangement having permanent magnets to excite a magnetic flux, a flux-guiding carrier having two axially opposite end sides, wherein at least one of the end sides has carrier regions to which the permanent magnets are secured, and a binding arrangement for absorbing forces acting on the permanent magnets, which has a plurality of bindings extending axially through the carrier and at the end side over the permanent magnets to fix the permanent magnets to the associated carrier regions and to absorb forces acting axially on the permanent magnets, and where the carrier has axial passages through which the bindings are guided and which wrap the permanent magnets and the carrier regions.

### CROSS REFERENCE TO RELATED APPLICATION

This application claims priority under 35 U.S.C. § 119 from German Patent Application No. 10 2023 124 049.8, filed Sep. 7, 2023, the entire disclosure of which is herein expressly incorporated by reference.

### BACKGROUND AND SUMMARY

The invention relates to a rotor for an electric axial flux machine. The rotor has a permanent magnet arrangement having permanent magnets in order to excite a magnetic flux and a flux-guiding carrier having two axially opposite end sides, wherein at least one of the end sides has carrier regions, to which the permanent magnets of the permanent magnet arrangement are secured. Furthermore, the rotor has a binding arrangement for absorbing forces acting on the permanent magnets. The invention further relates to a method for producing the rotor, an axial flux machine and a motor vehicle.

In this instance, interest is directed toward axial flux machines for motor vehicles which can be used, for example, as electric drive machines for electric or hybrid vehicles. Such axial flux machines generally have at least one rotor and at least one stator, which with at least one air gap being formed are arranged axially adjacent to each other. An axially extending rotor shaft is in this instance connected in a rotationally secure manner to a carrier of the rotor. The at least one stator generally has stator windings which can be supplied with power in order to excite an axially directed, magnetic stator flux. In the case of an axial flux machine which is permanently excited, the rotor additionally has a permanent magnet arrangement having a plurality of permanent magnets in order to excite an axially directed, magnetic rotor flux. The permanent magnets may be in the form of surface magnets and be secured to at least one end surface of the carrier, for example, adhesively bonded. During operation of the electric axial flux machine, in particular the permanent magnets as a result of the rotating forces are exposed to forces by which the permanent magnets can become released from the carrier. To this end, from the prior art, for example, from EP 3 480 930 A1, it is known to provide the rotor with a binding arrangement. This binding arrangement surrounds the permanent magnets radially in order to absorb the centrifugal forces which act radially on the permanent magnets during operation.

During operation of the axial flux machine, however, a radially external outer region of the carrier may also become axially deflected and in this instance the permanent magnets in a radially internal inner region of the carrier are axially lifted off in the direction of the stator. However, this cannot be prevented with the binding arrangement radially surrounding the permanent magnets according to the prior art. In order to prevent the axial lifting of the permanent magnets, the axial flux machine which is known from the prior art is limited with respect to the maximum speed thereof.

An object of the present invention is to configure a mechanical connection between a carrier and permanent magnets of a rotor of an axial flux machine in a particularly reliable and stable manner.

This object is achieved according to the invention by a rotor, a method for producing the rotor, an axial flux machine and a motor vehicle having the features according to the independent patent claims, respectively. Advantageous embodiments of the invention are set out in the dependent patent claims, the description and the Figures.

A rotor according to the invention for an electric axial flux machine has a permanent magnet arrangement having permanent magnets in order to excite a magnetic flux and a flux-guiding carrier having two axially opposite end sides. At least one of the end sides of the carrier has carrier regions to which the permanent magnets are secured. Furthermore, the rotor comprises a binding arrangement for absorbing forces acting on the permanent magnets. The binding arrangement has a plurality of bindings which extend axially through the carrier and at the end side over the permanent magnets in order to fix the permanent magnets to the associated carrier regions and to absorb forces acting axially on the permanent magnets. To this end, the carrier has axial passages through which the bindings are guided and in this instance wrap the permanent magnets and the respective associated carrier region.

The invention further relates to a method for producing the rotor. In this instance, the permanent magnets are secured to the carrier regions of at least one of the end sides of the carrier, in particular adhesively bonded. Accordingly, ends of the bindings are guided through the passages and, with an axial wrapping being formed, in particular thermally, connected. The invention further relates to an axial flux machine having at least one stator and at least one rotor according to the invention, wherein the at least one stator and the at least one rotor, with at least one air gap being formed, are arranged axially adjacent to each other. A motor vehicle according to the invention comprises at least one axial flux machine according to the invention. The motor vehicle is in particular an electric motor vehicle and has the at least one axial flux machine as an electric drive machine.

The rotor has the carrier which is configured to guide a magnetic rotor flux which is excited by the permanent magnets of the rotor and a magnetic stator flux which is excited by a component which generates a magnetic field, in particular a stator winding, of the at least one stator. To this end, the carrier may have a magnetically conductive material, for example, iron. The carrier may have a solid material or a laminated core. The carrier is in particular in the form of an annular disk and has a circular outer edge and a circular inner edge. Via the inner edge, the carrier is connected in a rotationally secure manner to a rotor shaft which extends axially along a rotation axis of the rotor. The rotor has a plurality of rotor poles which are arranged with alternating polarity in a circumferential direction about the rotation axis. In particular, a segment of the carrier is associated with each rotor pole. Radially orientated edges of a segment correspond to pole edges of the respective rotor pole. The carrier has axially opposite annular end sides or end surfaces, wherein at least one of the end sides is directed toward the stator. In the case of an electric axial flux machine having only one stator, only one of the end sides of the rotor faces the stator. In the case of an axial flux machine having two stators, between which the rotor is arranged, both end sides each face a stator.

At the at least one end side, facing the stator, of the carrier, permanent magnets are secured. The permanent magnets are in particular in the form of an annular segment or in the form of a piece of cake and arranged in an annular manner in a circumferential direction about the rotor axis. In particular, at least at one end side of the carrier, a permanent magnet which is integral or which is segmented into multiple parts in a circumferential direction is arranged in each segment. In the case of the rotor which is equipped at one side, a permanent magnet is thus associated with each rotor pole. In the case of the rotor which is equipped at both sides, two axially opposite permanent magnets are associated with each rotor pole. The permanent magnets are in the form of surface magnets, the lower sides of which rest in the respective carrier region on the carrier and are secured to the carrier. The connection between the permanent magnets and the carrier is in particular a materially engaging connection, for example, an adhesive bonding. The upper sides of the permanent magnets adjoin the air gap which is formed between the stator and the rotor.

The carrier regions or support faces for the permanent magnets extend in a radial direction between an annular inner region, which adjoins the inner edge, of the end side and a radially external outer region, which adjoins the outer edge, of the carrier. Preferably, the carrier has in the inner region and in the outer region of the carrier a greater axial thickness than in the carrier regions so that the carrier has an annular recess at at least one end side. This annular recess has the carrier regions for the permanent magnets. The inner region and outer region of the carrier which are axially raised with respect to the carrier regions form annular, web-like, radial delimitations for the permanent magnets by which a radial displacement of the permanent magnets can be prevented. To this end, the permanent magnets bear with their radially internal, circular-segment-like inner side against the inner region of the carrier and with their radially external circular-segment-like outer side against the outer region of the carrier. An upper side of the outer region and an upper side of the permanent magnets are in this instance in particular arranged flush with respect to each other so that the permanent magnets do not protrude in an axial direction beyond the outer region, that is to say, do not protrude on the carrier. In the case of a carrier which is equipped at both sides, the inner region and the outer region may protrude axially in both directions so that the carrier, for example, at least partially is in the form of an H-profile. In the case of a carrier which is equipped at one side, the inner region and the outer region can protrude axially only in one direction facing the stator so that the carrier is at least partially, for example, in the form of a U-profile.

The at least one permanent magnet of each rotor pole is in this instance additionally secured to the carrier by a binding. This binding forms an annular, axial wrapping which surrounds the carrier in the carrier region and the at least one permanent magnet which is arranged axially thereon. The at least one permanent magnet per rotor pole is thus securely connected to the carrier by the binding by the permanent magnet and the carrier region being surrounded or wrapped around axially and at the end with the axial wrapping of the binding being formed. These bindings have in particular a glass fiber material or a carbon-fiber-reinforced plastics material (CFRP). These materials can be thermally connected in order to close the bindings, for example, welded.

In order to penetrate the carrier, the carrier has a plurality of passages which are arranged in a state distributed in a circumferential direction. For example, two passages which are spaced apart in a circumferential direction and which extend radially partially and axially completely through the carrier may be associated with each rotor pole, between which passages the at least one permanent magnet of the rotor pole is arranged. The passages are in this instance arranged in the region of the pole edges and adjoin in particular the respective carrier region. Ends of the bindings are inserted through the passages and connected at the end side, for example, welded. Consequently, each binding has two first portions which extend axially and two second portions which extend tangentially at the end side. The first portions are in this instance arranged in the axial passages or openings of the carrier and at side regions of the permanent magnets. At least a second portion extends over the upper side of the permanent magnets. In the event that only one end side is fitted with permanent magnets, a second portion extends over the non-equipped end side of the carrier. Therefore, the bindings extend partially axially and consequently absorb axial forces which act during operation of the axial flux machine on the permanent magnets and by which the permanent magnets can be partially axially raised from the carrier. Consequently, the permanent magnets are fixed to the carrier in a particularly reliable manner and the axial flux machine is advantageously also suitable for high speeds.

Preferably, the bindings are arranged only in a first part-region, which adjoins the inner region and which is radially spaced apart from the outer region, of the carrier regions of the rotor. A second part-region which extends radially between the first part-region and the outer region is configured without bindings. The bindings thus cover the upper side of the permanent magnets in a radial direction only partially. Only those portions of the permanent magnets which are at risk of becoming detached are fixed to the carrier by the bindings. These portions which are at risk of becoming detached are in particular radially internal portions of the annular-segment-like permanent magnets which can become detached separated from the carrier when the rotor rotates and can be raised axially in the direction of the stator.

In this instance, there may be provision for the permanent magnets to have a constant axial thickness in the radial direction so that the rotor in the first part-region which is provided with the binding arrangement has a greater axial length than in the second part-region. As a result of the thickness of the permanent magnets which is constant in a radial direction, the rotor has a constant magnetic flux in the radial direction. However, the binding which extends over the respective permanent magnet partially increases the axial length of the rotor and consequently ensures a variable air gap in a radial direction.

Alternatively, the permanent magnets have in the radial direction a variable axial thickness so that the rotor in the first part-region which is provided with the binding arrangement has approximately the same axial length as in the binding-free second part-region. In this instance, the air gap in a radial direction is constant, but the magnetic flux is not. In order to provide the variable thickness of the permanent magnets, they may at the transition between the first part-region provided with the binding and the second part-region have a step, wherein the permanent magnets in the first part-region have a first constant thickness and in the second part-region have a greater, second constant thickness in comparison with the first thickness. The height of the step thus corresponds approximately to the thickness of the binding so that the binding which is arranged in the permanent magnet portion of the first part-region terminates flush with the permanent magnet portion in the second part-region. Alternatively, the permanent magnets may be configured in a wedge-like manner and have a thickness which increases continuously in the radial direction.

The passages may be in the form of radially orientated slots in the carrier which are orientated parallel with pole edges so that bending edges of the bindings are radially orientated and extend parallel with the side faces of the permanent magnets. In a plan view of the end side of the rotor, each binding has in this instance a trapezoidal shape, wherein the bending edges of the bindings are orientated obliquely with respect to each other. A width of the slots is in this instance only slightly greater than a thickness of the binding so that, as a result of the slots, the smallest possible material loss occurs at the carrier. A carrier which is configured in this manner is particularly stable.

Alternatively, the passages are in the form of cavities, the inner walls adjacent to the carrier regions of which are constructed parallel with an axis which extends at the center of the pole so that bending edges of the bindings are orientated parallel with each other and parallel with the axis which extends at the center of the pole. The cavities form an opening for the bindings which is larger in comparison with the slots so that the ends of the bindings can be guided in a simpler manner through the carrier and the binding arrangement can be produced in a simpler manner. For example, a cavity may extend over two rotor poles so that two adjacent rotor poles each share a cavity. In a plan view of the end side of the rotor, each binding has in this instance a rectangular shape. By this embodiment, the carrier and consequently the rotor have a particularly small weight.

The embodiments which have been set out with respect to the rotor according to the invention and the advantages thereof apply accordingly to the method according to the invention, the axial flux machine according to the invention and the motor vehicle according to the invention.

Other features of the invention will be appreciated from the claims, the Figures and the description of the Figures. The features mentioned above in the description and feature combinations and the features and feature combinations mentioned below in the description of the Figures and/or set out in the Figures alone can be used not only in the combination set out but also in other combinations or alone.

The invention is now explained in greater detail with reference to a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1a, 1b, 1c, and 1d show different views of a segment of a rotor in a first embodiment;

FIGS. 2a, 2b, 2c, and 2d show different views of a segment of a rotor in a second embodiment;

FIGS. 3a, 3b, 3c, and 3d show different views of a segment of a rotor in a third embodiment; and

FIGS. 4a, 4b, 4c, and 4d show different views of a segment of a rotor in a first embodiment.

### DETAILED DESCRIPTION OF THE DRAWINGS

In the Figures, elements which are identical and functionally identical are provided with the same reference numerals.

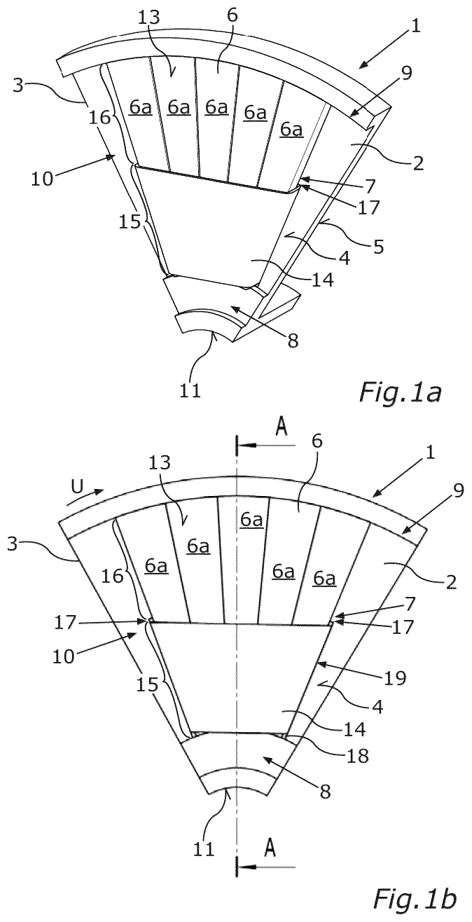

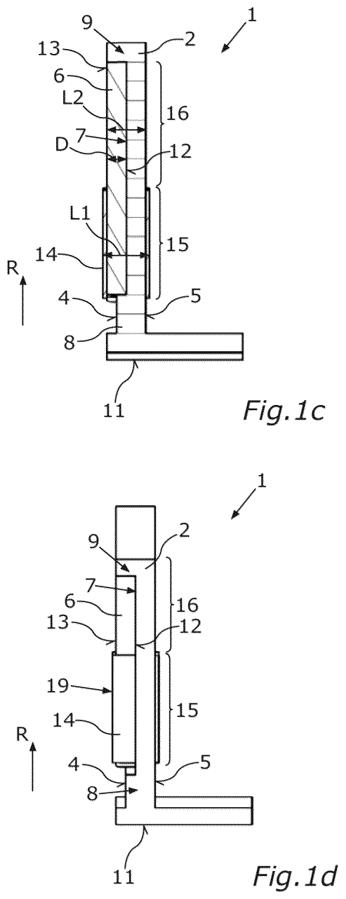

FIGS. 1a, 1b, 1c and 1d, FIGS. 2a, 2b, 2c and 2d, FIGS. 3a, 3b, 3c and 3d and FIGS. 4a, 4b, 4c and 4d show different embodiments of a rotor 1 for an axial flux machine from different perspectives. FIGS. 1a, 2a, 3a, 4a show in each case a perspective illustration of a rotor pole of the rotor 1, FIGS. 1b, 2b, 3b, 4b show a plan view of the rotor pole of the rotor 1, FIGS. 1c, 2c, 3c, 4c show a section through the respective rotor pole of the line of section AA′ through the pole center and FIGS. 1d, 2d, 3d, 4d show a side view of the rotor pole at the pole edge.

The rotor 1 has a carrier 2 which is in the form of an annular disk. A segment 3 of the annular-disk-like carrier 2 is associated with each rotor pole in this case. The carrier 2 has two axially opposite end sides 4, 5. At least at one of the end sides 4, 5, in this instance only at the end side 4, a permanent magnet arrangement having permanent magnets 6 is arranged. The end side 4 which is provided with the permanent magnets 6 faces an axially adjacent stator (which is not shown in this instance) of the axial flux machine. Per rotor pole there is arranged in each case in this instance one annular-segment-like permanent magnet 6 which in this instance is segmented in the circumferential direction U and consequently comprises a plurality of subsegments 6a with the same polarity. As a result of the segmentation of the permanent magnet 6, eddy current losses are reduced. The end side 4 has carrier regions 7 for the permanent magnets 6 which are delimited in the radial direction R by an inner region 8 and an outer region 9 of the carrier 2. The inner region 8 and the outer region 9 are configured to be axially raised with respect to an intermediate region. This intermediate region forms an annular recess 10, on the planar surface of which the carrier regions 7 are located. In this instance, the inner region 8 is configured in two stages, wherein the inner region 8 forms on an inner edge 11 of the carrier 2 an abutment face for a rotor shaft which is not shown in this instance and which is connected to the carrier 2 in a rotationally secure manner.

The permanent magnet 6 bears in this instance with a lower side 12 against the respective carrier region 7. An upper side 13 axially opposite the lower side 12 faces an air gap between the rotor 1 and the stator. Between the lower side 12 and the carrier region 7, there may be located a layer of adhesive via which the permanent magnet 6 is connected to the carrier 2 in a materially engaging manner. In addition to the layer of adhesive, the permanent magnet 6 is secured to the carrier 2 with a binding 14. The binding 14 acts as a securing device via which the permanent magnet 6 is connected to the carrier 2. In the bound state, the binding 14 is closed in an annular manner and wraps around the permanent magnet 6 and the associated carrier region 7. The binding 14 is arranged in this instance in a first part-region 15, which is adjacent to the inner region 8, of the carrier 2 and extends axially through the carrier 2 and over the upper side 13 of the permanent magnet 6 and over the end side 5 of the carrier 2. During operation of the rotor 1, it may be the case that a second part-region 16 which adjoins the first part-region 15 bends axially away from the stator. In order to prevent the permanent magnets 6 in the first part-region 15 from becoming axially displaced and detached from the carrier 2, the binding 14 is arranged in the first part-region 15.

In order to be able to guide the binding 14 through the carrier 2, it has axial passages 17 which are arranged in the region of the pole edges. These passages 17 are according to the exemplary embodiments shown in FIGS. 1a to 1d, 2a to 2d and 3a to 3d in the form of radially orientated slots 18. In this instance, each rotor pole and consequently each segment 3 of the carrier 2 has two slots 18 which are arranged with spacing from each other in a circumferential direction and between which the permanent magnet 6 is arranged.

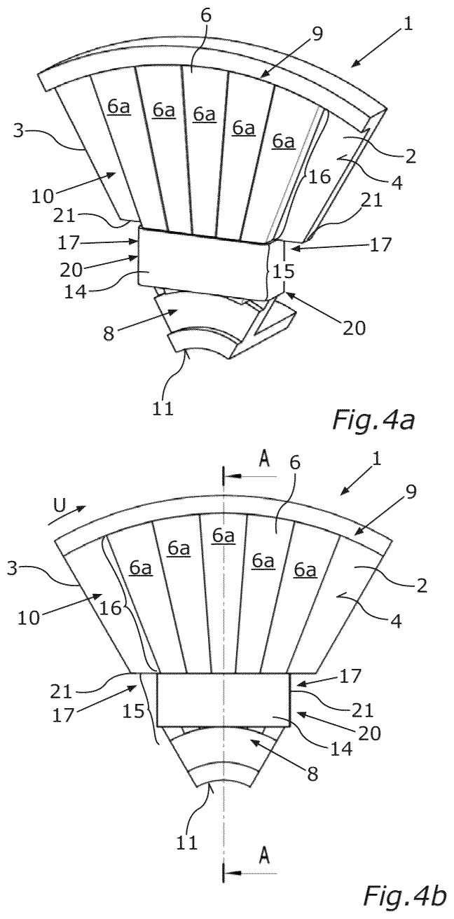

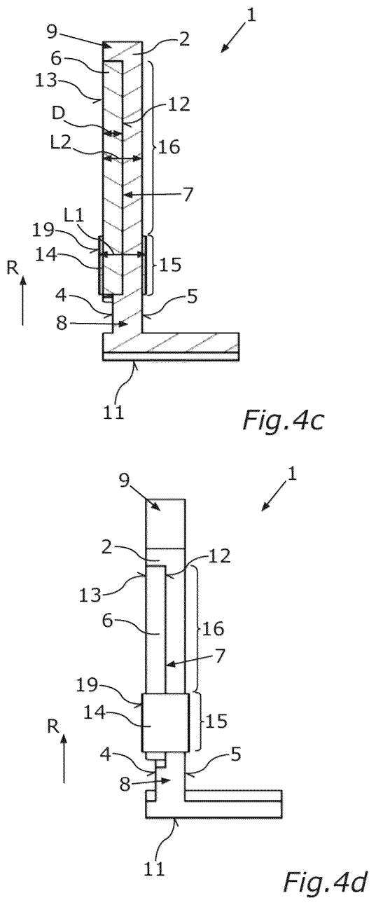

Consequently, the slots 18 are orientated parallel with side faces of the permanent magnet 6. Bending edges 19 of the bindings 14 which form the transition of the binding 14 from the side face of the permanent magnet 6 to the surface 13 or to the end side 5 of the carrier 2 are thereby radially orientated. According to the exemplary embodiments shown in FIGS. 4a to 4d, the passages 17 are in the form of cavities 20, wherein a wall, which faces the permanent magnet 6, of the cavity face 20 and consequently the bending edges 19 of the bindings 14 are configured parallel with an axis which extends through the pole center. In this instance, the cavities 20 are in the form of tangential constrictions of the segment 3 in which the edges of the segment 3 have notches 21 which extend in the direction of the pole center.

In the exemplary embodiments of the rotor 1 according to FIGS. 1a to 1d and 4a to 4d, the permanent magnet 6 (see in particular FIG. 1c) has in the radial direction R a constant axial thickness D. The rotor 1 thereby has in the first part-region 15, as a result of the binding 14 which extends over the permanent magnet 6, a first length L1 which is greater than a second length L2 in the binding-free second part-region 16 (see FIG. 1d), Consequently, the length L1, L2 of the rotor 1 in the radial direction R is not constant.

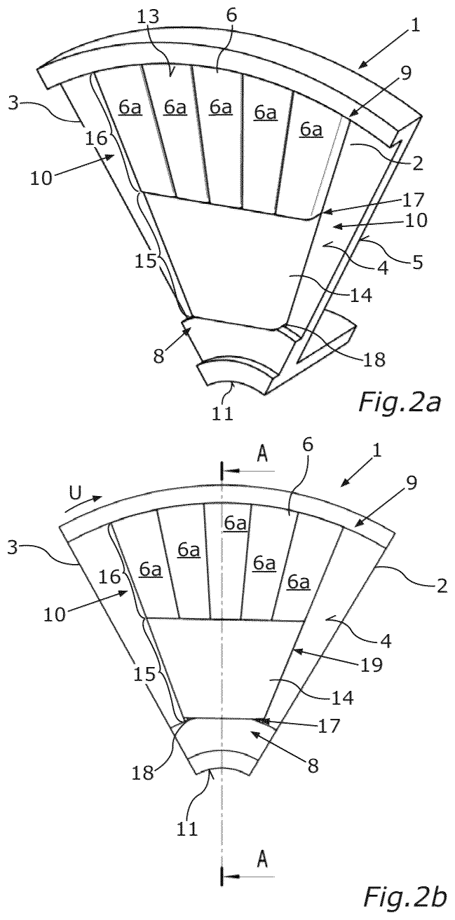

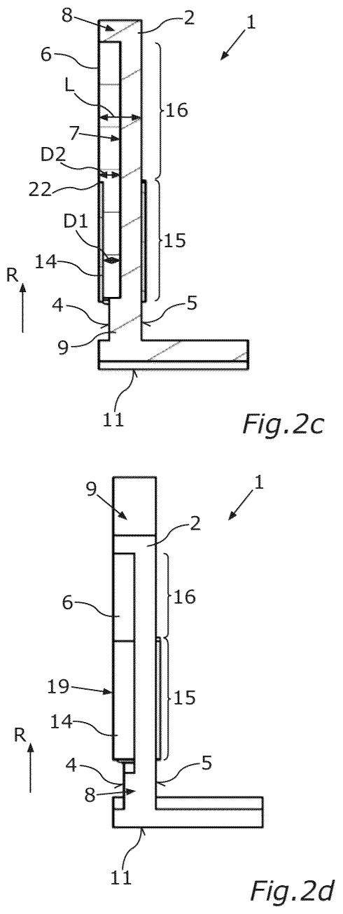

In the exemplary embodiment of the rotor 1 according to FIGS. 2a to 2d, the permanent magnet 6 (see in particular FIG. 2c) has in the radial direction T in the first part-region 15 a first thickness D1 and in the second part-region 16 a greater second thickness D2. A step 22 is formed at the transition between the first part-region 15 and the second part-region 16, wherein a height of the step 22 corresponds to a thickness of the binding 14. An axial length L of the rotor 1 in the radial direction R over the part-regions 15, 16 is thereby constant.

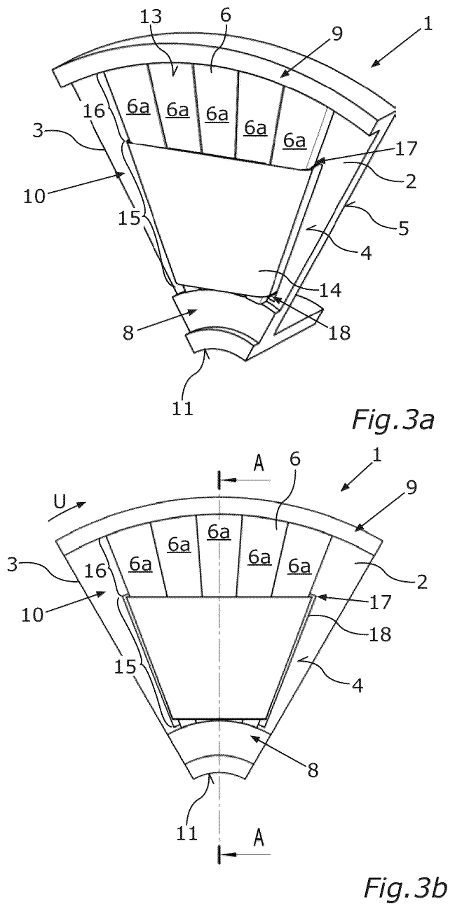

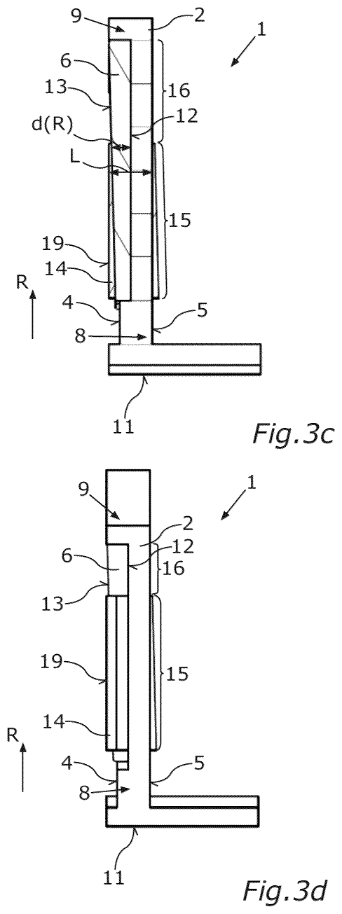

In the exemplary embodiment of the rotor 1 according to FIGS. 3a to 3d, the permanent magnet 6 (see in particular FIG. 3c) has in the radial direction R a variable thickness d(R). This thickness d(R) increases in this instance in a linear manner outward in the radial direction R. An axial length L of the rotor 1 in the radial direction R is thereby also substantially constant.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotor for an electric axial flux machine, comprising:
a permanent magnet arrangement having permanent magnets configured to excite a magnetic flux;
a carrier having two axially opposite end sides, wherein at least one of the end sides comprises carrier regions, to which the permanent magnets of the permanent magnet arrangement are secured; and
a binding arrangement configured to absorb forces acting on the permanent magnets, wherein the binding arrangement comprises a plurality of bindings which extend axially through the carrier and, at the at least one of the end sides of the carrier, extend over the permanent magnets to fix the permanent magnets to associated carrier regions and to absorb forces acting axially on the permanent magnets, and
wherein the carrier comprises axial passages through which the bindings are guided and which wrap the permanent magnets and the carrier regions.

2. The rotor according to claim 1, wherein
the permanent magnets are additionally secured to the carrier regions in a materially engaging manner comprising an adhesive bond.

3. The rotor according to claim 1,
wherein the carrier is in the form of an annular disk and comprises a radially internal inner region which faces a central opening for a rotor shaft, and a radially external outer region, wherein the carrier regions extend radially between the inner region and the outer region,
wherein the permanent magnets are in the form of annular segments,
wherein the rotor has a plurality of rotor poles which are located adjacent to each other in a circumferential direction and which have alternating polarity, and
wherein a segment of the carrier, at least one permanent magnet in the form of the annular segment, two axial passages, and a binding are associated with each rotor pole.

4. The rotor according to claim 3,
wherein the bindings are arranged only in a first part-region of the carrier regions that is adjacent to the inner region, and which is radially spaced apart from the outer region, which are provided with the permanent magnets of the rotor.

5. The rotor according to claim 3,
wherein the carrier has, in the inner region and in the outer region, a greater axial thickness than in the carrier regions so that the carrier, at least at one end side, has an annular recess between the inner region and the outer region, wherein the annular recess comprises the carrier regions for the permanent magnets.

6. The rotor according to claim 4,
wherein the permanent magnets comprise, in a radial direction, a constant axial thickness so that the rotor in the first part-region that is provided with the binding arrangement has a first axial length, and in a second part-region of the carrier regions that is adjacent to the first part-region and the outer region, has a second axial length that is smaller compared with the first axial length.

7. The rotor according to claim 4,
wherein the permanent magnets have, in a radial direction, a variable axial thickness so that the rotor in the first part-region that is provided with the binding arrangement has substantially a same axial length as in a second part-region of the carrier region that is adjacent to the first part-region and the outer region.

8. The rotor according to claim 7,
wherein the permanent magnets at a transition between the first part-region that is provided with the binding and the second part-region that is binding-free includes a step,
wherein the permanent magnets in the first part-region have a first constant thickness and in the second part-region have a second constant thickness that is greater in comparison with the first thickness.

9. The rotor according to claim 7,
wherein the permanent magnets are configured in a wedge-like manner and have a thickness that increases continuously in the radial direction.

10. The rotor according to claim 1,
wherein the axial passages are in the form of radially orientated slots in the carrier so that bending edges of the bindings are orientated parallel with radially orientated side faces of the permanent magnets.

11. The rotor according to claim 1,
wherein the axial passages are in the form of cavities, wherein inner walls of the cavities adjacent to the carrier regions are constructed parallel with an axis which extends at a center of the pole so that bending edges of the bindings are orientated parallel with each other and with the axis which extends at the center of the pole.

12. The rotor according to claim 1,
wherein ends of the bindings are thermally connected to each other in order to form a respective closed axial wrapping in a connection region.

13. A method for producing a rotor according to claim 1, the method comprising:
securing the permanent magnets in the carrier regions to at least one of the end sides of the carrier;
guiding ends of the bindings through the passages; and
connecting ends of the bindings with an axial wrapping for the permanent magnets and the carrier regions being formed.

14. An axial flux machine comprising:
a stator; and
the rotor according to claim 1, wherein the stator and the rotor are arranged axially adjacent to each other.

15. A motor vehicle comprising:
the axial flux machine according to claim 14.
